(19) United States
(12) Patent Application Publication
(10) Pub. No.: US 2007/0098235 A1
(43) Pub. Date: May 3, 2007

(54) Age Verification

(76) Inventors: Uriel Halavee, Ramat-Gan (IL); Shmuel Bukshpan, Ramat-Hasharon (IL)

Correspondence Address: WOLF, BLOCK, SCHORR & SOLIS-COHEN LLP, 250 PARK AVENUE, NEW YORK, NY, 10177, US

(21) Appl. No.: 11/535,661

(22) Filed: Sep. 27, 2006

Related U.S. Application Data
(60) Provisional application No. 60/722,622, filed on Sep. 29, 2005.

(51) Int. Cl. G06K 9/00

(52) U.S. Cl. 382/124

(57) ABSTRACT

A method of estimating a range of age of a subject, the method comprising: a) making at least one measurement of epidermal ridges of the subject; and b) estimating at least a range of age of the subject, using the measurements of the epidermal ridges, without using the measurements to identify the subject.

### RELATED APPLICATIONS

This application claims the benefit under 35 U.S.C. 119(e) of U.S. provisional application 60/722,622, filed Sep. 29, 2005, the disclosure of which is incorporated herein by reference.

### FIELD OF THE INVENTION

The field of the invention relates to automatic age verification, for example to restrict access to a resource to those who are above a certain age.

### BACKGROUND OF THE INVENTION

There is a need to prevent access by children to dangerous material or equipment, such as drugs, including alcohol and cigarettes, weapons, certain tools, and flammable materials, as well to forms of entertainment, such as gambling and pornography, that are deemed inappropriate for children, whether in physical space or cyberspace. It is often not practical to use a human guard, capable of distinguishing adults from children, to guard such sites, and various methods have been used to limit access automatically. While passwords are a commonly used technique, passwords can be guessed or otherwise obtained illegitimately by individuals who are under the desired minimum age for access. Hence, various biometric methods have been proposed and used to limit access.

Biometric methods have included the use of fingerprints, patterns of the iris, and facial features, to identify individuals by comparing these features to an image in a database, which also includes information about the age of the individual. Examples, all using fingerprints, include U.S. Pat. No. 6,807,291 to Tumey et al, published patent applications US 2004/153421 to Robinson and US 2002/039432 to Sheena, WO 2004/025397 to Chatigny et al, and JP 2002/117443 to Yamamoto. However, building such a database may be time-consuming and costly, and may raise issues of privacy.

Published patent application US 2004/0088553 A1 describes the use of ultrasonic measurement of bone mineral content, to distinguish between adults and children.

Japanese patent JP 2004/297468 to Shinozaki describes measuring the width of the thumb or another finger pressed against a flat sensor, as well as measuring the pressure, to distinguish adults from children. An advantage of this method, pointed out in JP 2004/297468, over methods using fingerprint identification, is that it is possible to use a simple, inexpensive sensor, rather than a sophisticated sensor such as would be needed to record a fingerprint.

M. Kralik and V. Novotny, “Epidermal Ridge Breadth: An Indicator of Age and Sex in Paleodermatoglyphics,” Variability and Evolution 11, 5-30 (2003), describes a method of determining the age and sex of potters who left fingerprints on ancient pottery, by measuring the distance between ridges on the fingerprints, and taking into account the shrinkage of the pottery when it was fired.

The disclosures of the above mentioned patents and publications are incorporated herein by reference.

### SUMMARY OF THE INVENTION

An aspect of some embodiments of the invention relates to estimating an age, or at least a range of possible ages, for a subject, by making a measurement of the finger pad ridges of the subject, and using the results of the measurement to estimate the age. Optionally, the measurement comprises measuring a distance between adjacent ridges of the finger pad, or finding an average distance between adjacent ridges, for example by counting the number of ridges in a given interval.

It should be noted that the dictionary definition of “fingerprint” is a mark, for example an ink mark on paper, made by the ridges of the finger, and would not include a photographic or digital image of the finger itself, showing the ridges. Since modern “fingerprint” identification methods often work from images of the finger, rather than from “fingerprints” as defined in the dictionary, the term “finger pad” is used herein to refer to the part of the finger (the palm side of the end of the finger) that is traditionally used to make fingerprints that are used for identification, and the ridges will be referred to as “finger pad ridges.” As used herein, “making a measurement of finger pad ridges” includes both direct measuring of the finger pad ridges, and indirect measuring of the finger pad ridges, by measuring “fingerprints” in the dictionary sense.

In some embodiments of the invention, instead of using finger pad ridges, other epidermal ridges, such as ridges on other parts of the finger, or on the palm of the hand, are used. Ridges on the toes and the soles of the feet may also be used. The details of how the measurement is used to estimate age may be different for epidermal ridges on different parts of the body.

In some embodiments of the invention, the measurement of the finger pad ridges is combined with other biometric measurements, for example voice characteristics such as pitch, finger dimensions, and variations in the skin, for example in smoothness, which may increase the accuracy of the age estimate.

In some embodiments of the invention, the estimate of age is used as a basis for allowing or denying the subject access to a resource. For example, the subject is allowed access to an adults-only web site if the subject is estimated to be more than 18 years old. Alternatively, the subject is given access to a resource, for example a chat group for children, only if the subject is estimated to be below a certain age.

In some embodiments of the invention, the finger pad ridges are monitored continuously or frequently, for example to make sure that an adult does not use his finger pad to gain access to the resource for a child, and then go away. Using characteristics of the finger pad ridges to estimate age, rather than using the finger pad ridges to establish identity through a database, is potentially advantageous in a system that monitors a finger pad continuously or frequently, because the time needed to estimate age from characteristics of the finger pad may be much shorter than the time needed to establish identity using a finger pad image. Using the toes or feet may be particularly useful for continuous monitoring, since the fingers can be free to type, for example.

In some embodiments of the invention, which use finger pad ridges only for estimating age, there is no need for a database listing which individuals are of the proper age to be allowed access. In other embodiments of the invention, finger pad ridges are used both for establishing identity from a database and for estimating age based on characteristics of the finger pad ridges.

Because finger pad ridges are widely used in identity-based systems, apparatus for scanning finger pad ridges and storing their images is widely available. Some embodiments of the invention can be implemented using off-the-shelf hardware and new software.

There is thus provided, in accordance with an exemplary embodiment of the invention, a method of estimating a range of age of a subject, the method comprising:
a) making at least one measurement of epidermal ridges of the subject; and
b) estimating at least a range of age of the subject, using the measurements of the epidermal ridges, without using the measurements to identify the subject.

In an embodiment of the invention, the method also includes scanning the epidermal ridges to produce a scanned image, and making the measurement comprises analyzing the scanned image.

Optionally, the measurement comprises a measurement of an average distance between adjacent epidermal ridges.

Optionally, the epidermal ridges are on a finger pad.

Optionally, the finger pad is an index finger pad, and the subject is estimated to be under 17 years old if an average distance between adjacent ridges is less than 0.477 mm when the index finger is pressed against a surface.

Optionally, the finger pad is an index finger pad, and the subject is estimated to be at least 17 years old if an average distance between adjacent ridges is at least 0.477 mm when the index finger is pressed against a surface.

Optionally, the average distance between adjacent ridges is an average over ridges in a region of the skin where the ridges are substantially straight. Additionally or alternatively, estimating the range of age comprises using other biometric data of the subject, combined with the average distance between adjacent ridges.

Optionally, the other biometric data comprises a measure of the width of a finger pad.

Optionally, the subject is estimated to be at least 17 years old if the product of the average distance between adjacent ridges of the index finger pad, and the width of the index finger pad, is greater than 6.60 mm² when the index finger is pressed against a surface.

Optionally, the subject is estimated to be less than 17 years old if the product of the average distance between adjacent ridges of the index finger pad, and the width of the index finger pad, is less than 6.60 mm² when the index finger is pressed against a surface.

Optionally, the other biometric data comprises data of the voice of the subject.

In an embodiment of the invention, the subject is estimated to be an adult or not an adult, depending on whether a measure of the epidermal ridges on a subject is greater than or less than a value, the value being selected according to distributions of said measure for a population of adults and for a population of youths.

Optionally, at least 70% of the population of adults have said measure greater than the value.

Optionally, at least 70% of the population of youths have said measure less than the value.

Optionally, the percentage of the population of youths who have said measure less than the value is substantially equal to the percentage of the population of adults who have said measure greater than the value.

Optionally, the population of youths is between 13 and 16 years old.

Optionally, the measure is an average distance between adjacent epidermal ridges on one of the finger pads.

Optionally, the measure is the product of an average distance between adjacent epidermal ridges on one of the finger pads, and a width of said finger pad.

In an embodiment of the invention, the method also includes deciding whether to permit or deny the subject access to a resource, depending on the estimated range of age.

Optionally, the resource comprises a pornographic website.

Optionally, the resource comprises a gambling website.

Optionally, the resource comprises an internet site for children, and the subject is denied access if the estimated range of age is greater than a maximum age.

There is further provided, in accordance with an exemplary embodiment of the invention, apparatus for estimating a range of age of a subject, the apparatus comprising:
a) a data acquisition device adapted to obtain data of the subject's epidermal ridges; and
b) an analyzer adapted to obtain at least one measurement of an average distance between adjacent epidermal ridges by analyzing the data, and to estimate the range of age of the subject by analyzing the at least one measurements.

Optionally, the data acquisition device has a resolution that is worse than 0.05 mm.

Optionally, the data acquisition device has a resolution that is worse than 0.1 mm.

There is further provided, in accordance with an exemplary embodiment of the invention, a system for controlling access to a resource by users under a minimum age for access, the system comprising:
a) apparatus according to an embodiment of the invention, adapted to estimate the range of age of each of the users; and
b) a controller, adapted to deny access to a user, according to a relationship between the estimated range of age of the user, and the minimum age for access.

Optionally, the apparatus is also adapted to establish the identity of a user by comparing imaging data of the user's finger pad to a database of finger pad ridge patterns, and the controller is adapted to deny access to the user, according to the estimated range of age of the user, or the identity established for the user, or both.

Optionally, the apparatus is adapted to repeatedly estimate the age of each user while said user is using the resource, and the controller is adapted to terminate access by said user according to a relationship between an estimated range of age of the user made while the user is using the resource, and the minimum age for access.

### BRIEF DESCRIPTION OF THE DRAWINGS

Exemplary embodiments of the invention are described in the following sections with reference to the drawings. The drawings are generally not to scale. Features found in one embodiment can also be used in other embodiments, even though not all features are shown in all drawings.

FIG. 1 is a schematic view of a system of access control, according to an exemplary embodiment of the invention;

FIG. 2 is a schematic view of the ridges on a portion of a finger pad, used by the system of FIG. 1 for estimating age;

FIG. 3A is a schematic plot of distributions of fingerprint ridge spacing for subjects of different age ranges; and

FIG. 3B is a schematic plot of distributions of the product of fingerprint ridge spacing and fingerprint width, for subjects of different age ranges.

### DETAILED DESCRIPTION OF EXEMPLARY EMBODIMENTS

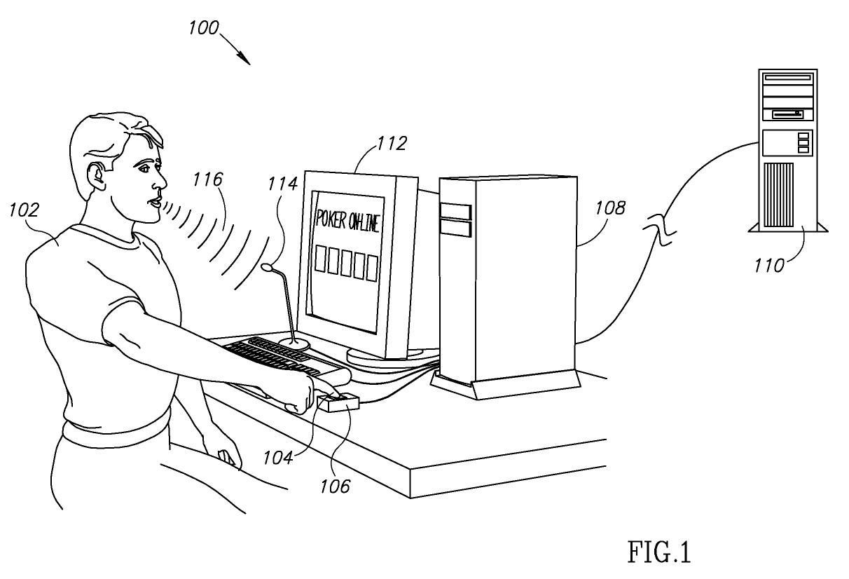

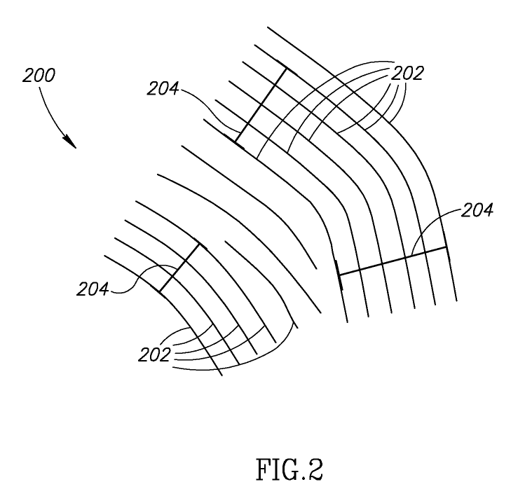

FIG. 1 schematically shows a system 100 for access control. A subject, in this case an internet user 102, places his finger 104 on a finger pad scanner 106. Optionally, scanner 106 is an off-the-shelf finger pad scanner, of the kind used to scan finger pad ridges for identity-based systems for access control, for example a built-in finger pad scanner in a laptop. Data measured by the scanner is sent to an analyzer, a computer 108, which analyzes the data in order to estimate a range of age of user 102. Although typically the analyzer is a computer, it need not be a standard digital computer, but could be any device which analyzes data, including, for example, RISC chips, or dedicated analog and/or digital circuits. Typically, scanner 106 generates imaging data of the finger pad ridges, although in some embodiments of the invention scanner 106 may perform some analysis of the finger pad ridges on its own, and sends the results of the analysis to computer 108. Details of the analysis, whether performed by computer 108 or scanner 106, are provided below in the description of FIG. 2.

Computer 108 optionally sends its estimate of the range of age of user 102 to a server 110 for an internet site that user 102 is trying to gain access to. For example, the site could be an online gambling site, such as that shown on monitor 112. If the range of age is within the range permitted access to the site, for example at least 18 years old, then the server allows user 102 to gain access. If the estimate of range of age of user 102 is not within the range permitted access to the site, then the server denies access to the user, or may require additional evidence of age, for example if the estimated range of age is marginal. Alternatively, for example if system 100 is being used as part of a parental control system on computer 108, then computer 108 need not send information about user 102 to server 110, but decides on its own, based on the age estimate, and optionally based on knowing an age range that server 110 establishes for allowing access to the internet site, whether to allow or deny the user access to the internet site, or to a program running locally on computer 108. Alternatively, server 110 runs its own software to estimate the age of the user, based on fingerprint imaging data from scanner 106, or based on a measurement of epidermal ridge spacing made by computer 108 or scanner 106, which computer 108 uploads to server 110. It should be understood that, whenever computer 108 is described as estimating the age of the user, the estimate could be made instead by server 110, using data supplied by computer 108.

Scanner 106 optionally can resolve features somewhat smaller than half the distance between adjacent ridges, for a young child. For example, the scanner has a spatial resolution of 0.2 mm, 0.15 mm, 0.10 mm, 0.07 mm, 0.05 mm, or less. The scanner need not be capable of scanning the entire width of a finger pad at once, if the scanned image is not being used to compare the entire pattern of ridges to a database, but rather to measure the distance between adjacent ridges, optionally on only a relatively small portion of the finger pad, for example half of the width of the thumb, a third of the width of the thumb, or a quarter of the width of the thumb. The width of the scanned region could be, for example, only 1 cm across, or only 5 mm across. In some embodiments of the invention, the spacing between ridges is determined by counting the number of ridges in a given interval, generally in an interval that is short enough so that the ridges are at least approximately parallel within that distance. In those embodiments, only a relatively small scanned region may be needed. However, it may be advantageous for the scanned image to be wide enough to include the entire finger pad, for example 2 cm or 3 cm wide, if the width and/or length of the finger pad is also being measured, and used to estimate the age of the subject.

The minimum contrast detected by the scanner is small enough to allow the ridges of the finger pad to be distinguished reasonably reliably from the valleys, although a certain degree of noise may be tolerated if the distance between ridges is found by averaging over several samples, since the error in measured distance between ridges will decrease due to the averaging. The contrast between the ridges and valleys may be increased by pressing the finger pad against a transparent window, and illuminating the finger pad at an angle such that the light undergoes total internal reflection inside the window material. Then only the ridges, which are in direct contact with the window surface with no air in between, are lit up. Requiring the user to press the finger pad against a transparent window also has the potential advantage that the distance between the ridges may be somewhat greater when the finger pad is pressed against a flat surface, and the measurements may be more reliable if the finger pad is always pressed against a flat surface when the measurements are made.

Similarly, the dynamic range of the scanner is adequate to distinguish the peaks from the valleys, optionally with a certain amount of noise, but need not be any greater. If the finger pad is pressed against a window and illuminated so that only the ridges are lit up, then the brightness of the ridges may be fairly uniform, and a rather small dynamic range, which includes the brightness of the ridges, may be sufficient to distinguish the ridges from the much darker valleys. If the finger pad is not pressed against a transparent window and illuminated in this way, then the brightness of the finger pad may be less predictable, and a higher dynamic range, as well as a greater ability to detect small changes in brightness, may be useful.

In general, the spatial resolution, brightness resolution, and dynamic range of the scanner need not be as great as they would be for a scanner which records an image of the finger pad ridge patterns for comparison to a database for identification.

Optionally, scanner 106 is a cell phone camera and computer 108 comprises the CPU, memory, screen and keyboard of a cell phone, and/or a computer that is part of a cell phone network. This embodiment of the invention may be useful if the user is trying to connect to an internet site using the cell phone.

Optionally, scanner 106, like most cell phone cameras, uses auto-focusing, and optionally scanner 106 is capable of sending information about distance, obtained for example from the auto-focusing feature, to computer 108, together with an image of the finger pad. Computer 108 then optionally uses the information about distance, together with the image, in order to determine the absolute spacing between ridges. Optionally, scanner 106 is itself capable of using the information about distance to calculate the absolute scale of an image of the finger pad, and conveys the absolute scale to computer 108 together with the image.

Optionally, software running on computer 108 or scanner 106 uses information obtained by scanner 106 to distinguish the finger pad of a living person from a picture of a finger pad that a user presents to scanner 106, for example in order to gain access fraudulently. For example, scanner 106 uses an auto-focus feature to determine a three-dimensional shape of the surface of the finger pad, verifying that it is not flat. Alternatively or additionally, scanner 106 obtains data showing temporal changes in the finger pad that may be used to determine that it belongs to a living person. For example, pressing the finger pad with a particular force against scanner 106 may reduce blood flow to the finger pad, resulting in a change in color that is measured by scanner 106. As another example, the finger pad is kept at a sufficiently warm temperature that drops of sweat start to form on its surface, and a sequence of images showing the increasing size of the drops is made by scanner 106.

In some embodiments of the invention, computer 108 estimates not just a single range of age, but a probability distribution of the age of user 102. In this case, access may be granted or denied according to the estimated probability that user 102 is above or below a minimum age. For example, user 102 is given access if computer 108 estimates that there is greater than a 50% probability that user 102 is at least the minimum age, or greater than an 80% probability that user 102 is at least the minimum age. The minimum age is, for example, 14, or 16, or 18, or any intermediate age, or any age lower than 14, or greater than 18. However, because most people reach their full size by about age 18, finger pad ridge measurements alone may not be adequate to distinguish different aged individuals above the age of 18, and supplementary data indicating age may be useful.

Optionally, adjustments are made for certain users who are known to be unusually small or unusually big for their age. For example, if system 100 is used as part of a parental control system for a particular child who is unusually big or unusually small for his age, then the software may include options to make appropriate adjustments in estimating the range of age of the user. As another example, system 100 is used by server 110 running an internet site with limited access based on age, and a particular user, who is unusually big or unusually small for his age, has authenticated his age by other means. Then, for example, a cookie is downloaded from server 110 to computer 108, so that, in the future, computer 108 will make appropriate adjustments in estimating his age, or server 110 will make appropriate adjustments in the estimated range of age.

Optionally, other data is used, in addition to the finger pad ridge data provided by scanner 106, in order to provide an improved estimate of the range of age of user 102. Such data may be used, for example, if the estimate of the range of age made by the finger pad ridge data alone is marginal with respect to the minimum age required for access. Two or more different types of data, used in combination, may provide a more reliable estimate of the range of age, or a narrower range of age, than either type of data used by itself. The additional data could include, for example, one or more of the following:
1) Acoustic data which a microphone 114 produces from sound waves 116 from the voice of user 102;
2) The total width of the finger pad of user 102, obtained from imaging data of the finger pad obtained by scanner 106;
3) Other data on the skin of user 102, obtained for example by scanner 106 or another scanner, relating, for example, to skin smoothness, size of the pores, hair follicles, veins located close to the surface, or other features of the skin which may change during adolescence;
4) An identity of user 102, established for example by comparing finger pad ridge data obtained by scanner 106 with a database of finger pad ridge patterns.

FIG. 2 shows a processed image 200 of at least a portion of the finger pad of user 102 which was scanned by scanner 106. Image 200 shows a map of the locations of finger pad ridges 202, typically a large number of ridges, such as ten or more. The locations of the ridges in a raw image of the finger pad may be found using any of the algorithms that are used by identity-based access control systems which employ finger pad ridges to identify users, to produce a map of the ridges. For example, pixels that have a local maximum in brightness, along at least one line passing through them, are identified as being the locations of the tops of ridges, and pixels that have a local minimum in brightness, along at least one line passing through them, are identified as being the locations of the bottoms of valleys between ridges. Alternatively, pixels which are above a brightness threshold are selected and their positions are fit to a set of smooth curve segments to tentatively identify the tops of ridges. Optionally, segments are then filtered out if they pass through pixels that have brighter pixels adjacent to them, not on that segment, and the remaining segments are then fitted to a smooth curve to identify the tops of ridges. An analogous procedure, but using pixels which fall below a minimum brightness threshold, is then optionally used to identify the bottoms of valleys between ridges, and valley curve segments are optionally rejected if they are not approximately parallel to, and within 0.5 mm of, a ridge top.

Adjacent finger pad ridges in a given finger pad typically are separated by a distance which is nearly constant for that person. By analyzing processed image 200, an average distance between adjacent ridges is found. Optionally, the analysis also determines other information, for example a standard deviation of the distance between adjacent ridges. If the standard deviation is sufficiently small, this fact helps to verify that the analysis has correctly found the average distance between ridges. If the distance between two adjacent ridges, as determined by the analysis, is unusually large in one case, for example if it is about twice as great as the distances between most other adjacent ridges, then this may indicate that a ridge has been missed in producing processed image 200. If the distance between two adjacent ridges is unusually small, it may indicate that the measurement was made near a point where two ridges bifurcate. In these cases, the distance between those ridges is optionally not included in finding the average distance between adjacent ridges. Additionally or alternatively, the median or mode of the distance between ridges may be found, rather than the mean, so that outliers do not affect the result, or have less effect on the result.

Optionally, the average distance between ridges is found by looking at a region of the finger pad where the ridges are substantially straight and free of bifurcations, so that a line segment 204 can be drawn across several ridges, such that the line segment is perpendicular to all of the ridges it crosses. Optionally, the ends of the line segment both fall on the centers of ridges or both fall halfway in between two ridges. An accurate average distance between ridges is then optionally found by dividing the length of the line segment by the number of ridges it crosses. Optionally, this procedure is repeated in a plurality of different locations on the finger pad, and an average of the results is found, for improved accuracy. Optionally, outliers are removed, before the average of the results is calculated, and/or the average of the results is a median or a mode of the results, so that it will not be affected so much by outliers.

If finger pad width is used, in addition to the average ridge distance, in order to estimate age, then optionally the thumb is measured if the user is trying to show that he is older than a minimum age, and the little finger is measured if the user is trying to show that he is younger than a maximum age. The user then has no motivation to use the wrong finger. Optionally, the software is capable of handling both cases.

Whether or not the finger pad width is used, the distance between ridges may be greater on some fingers, for example the thumb, than on other fingers, and the distance between ridges may be greater on one part of a finger pad than on other parts. Optionally, if the user is trying to show that he is older than a minimum age, then the distance between ridges is measured on a finger, for example the thumb, where the distance is greatest, and/or on a part of the finger pad where the distance is greatest is great. Optionally, if the user is trying to show that he is younger than a certain age, the distance between ridges is measured on a finger, for example the little finger, where the distance is smallest, and/or on a part of the finger pad where the distance is smallest.

A specific relationship between the average distance between adjacent ridges and the age of the person is described in the article by Kralik and Novotny, cited above. For example, if the average distance was 0.39 mm or less, then the person was almost certainly under 15 years old. If the average distance was 0.52 mm or more, then the person was probably at least 18 years old. These numbers were based on an average over fingerprints, from different fingers and different parts of the finger, found on ceramic pieces made by the people.

A study made by the inventors measured an average distance between ridges, and the total width, of index finger prints of each person in a sample of a population of adults over 25 years old, and each of each person in a sample of a population of youths between 13 and 16 years old. The prints were made with the index finger pressed against a flat surface. For each sample, the mean value and the standard deviation of the average distance between adjacent ridges, and the mean value and the standard deviation of the product of average ridge distance and fingerprint width, were calculated. The results are shown in Table 1.

TABLE 1
Results of study

| | Age range of people | |
|---|---|---|
| | 13 to 16 | Over 25 |
| Average distance between | Mean = 0.458 mm | Mean = 0.495 mm |
| ridges | S.D. = 0.027 mm | S.D. = 0.031 mm |
| Product of average | Mean = 5.821 mm² | Mean = 7.464 mm² |
| distance between ridges | S.D. = 0.658 mm² | S.D. = 0.782 mm² |
| and fingerprint width | | |

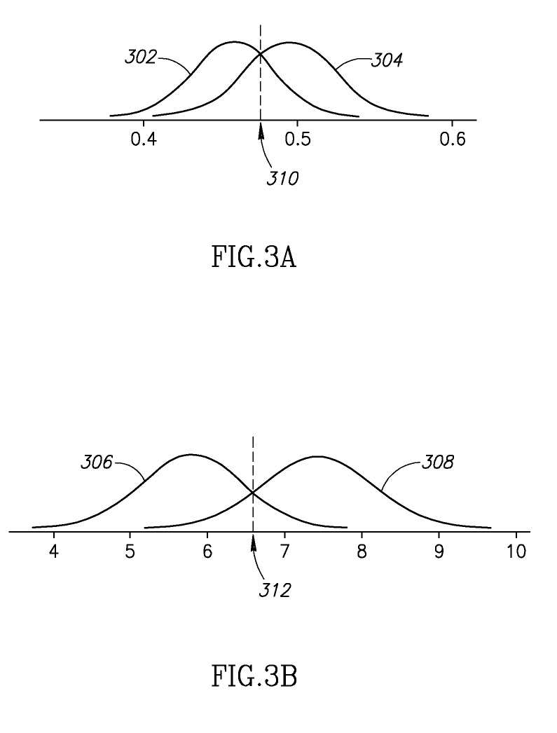

FIG. 3A shows Gaussian distributions of average distance between ridges. Distribution 302 has the same mean and standard deviation as the sample of 13 to 16 year old youths, and distribution 304 has the same mean and standard deviation as the sample of adults over 25, shown in the middle row of Table 1. FIG. 3B shows Gaussian distributions of the product of average distance between ridges and fingerprint width. Distribution 306 has the same mean and standard deviation as the sample of 13 to 16 year old youths, and distribution 308 has the same mean and standard deviation as the sample of adults over 25, shown in the bottom row of Table 1. Although the true distributions of these quantities in the general population may not be Gaussian, the sample size used in the study was not large enough to reliably tell how the true distributions for very large samples might differ from Gaussians. Fitting the data to Gaussian distributions is a convenient way to illustrate how the data can be used to choose a criterion for distinguishing youths from adults.

In FIG. 3A, distributions 302 and 304 intersect at a point 310, corresponding to an average distance between ridges of 0.477 mm. If having an average distance between ridges greater than 0.477 mm is chosen as the criterion to be considered an adult, for example at least 17 years old, then 70% of adults and 70% of 13 to 16 year old youths will be assigned to the correct group, as may be seen from the moderate overlap of distributions 302 and 304.

In FIG. 3B, distributions 306 and 308 do not overlap as much as distributions 302 and 304, and they intersect at a point 312, corresponding to a product of average ridge distance and fingerprint width of 6.60 mm². Because of the smaller overlap of distributions 306 and 308, using the product of average distance between ridges and fingerprint width is more reliable than using average distance between ridges, as a criterion for distinguishing adults from 13 to 16 year old youths. If having the product greater than 6.60 mm² is chosen as the criterion to be considered an adult, then 88% of adults and 88% of youths will be assigned to the correct group.

The criterion for distinguishing adults from youths need not be based on the value of the intersection of the two distributions as was done in the examples given above. It may be advantageous to base the criterion on a value that is greater than or less than this value. For example, if it is very important to exclude under-age users from access to an internet site, but it is not so important if a number of adult users are excluded as well, then the criterion for being considered an adult may be based on an average distance between ridges that is somewhat greater than 0.477 mm, such as 0.50 mm or 0.52 mm, or a larger value, or an intermediate value, or a product that is somewhat greater than 6.60 mm², such as 7.0 mm² or 7.5 mm², or a larger value, or an intermediate value. For example, if the criterion is based on an average distance between ridges of 0.495 mm, then, based on the distributions shown in FIG. 3A, 50% of the adults will be incorrectly classified as youths, but only about 8% of the youths will be incorrectly classified as adults. Conversely, if it is very important not to exclude more than a small number of adults, but not so important if youths are allowed access by mistake, then the criterion is optionally based on an average distance between ridges that is somewhat less than 0.477 mm, such as 0.46 mm or 0.43 mm, or a smaller value or an intermediate value, or a product that is somewhat less than 6.60 mm², such as 6.0 mm² or 5.5 mm², or a smaller value, or an intermediate value.

The criteria need not be based on the particular distributions shown in FIGS. 3A and 3B. As already noted, a study using a larger sample chosen from the same populations of adults and youths might show distributions that differ in shape from Gaussian, and in any case a larger sample might show different, possibly more accurate, mean values and standard deviations. The distribution may also differ depending on which finger is used, on how the data is measured, on what is being measured, and on characteristics of the population from which the sample is taken, for example nationality or ethnicity. For example, if the thumb is used instead of the index finger, then the average ridge distance and the total width of the fingerprint are generally expected to be greater, for a given subject. The age ranges for the adult and youth populations sampled may be different from the age ranges used in Table 1. The age ranges used may depend, for example, on the minimum access age for the system and on an expected age distribution for users seeking access to the system. Whatever distributions are found, methods similar to those described above, in FIGS. 3A and 3B, are optionally used to choose criteria for distinguishing users of different age ranges.

As used herein, “estimating a range of age” and similar phrases include estimating an exact age, since, for example, estimating an exact age in years is a special case of estimating a range of age where the range is only one year. As used herein, “a range of age” also includes a probability distribution of ages. Such a probability distribution amounts to one or more ranges of age, each with an associated probability, for example a range of age that the subject has a 50% probability of falling within, or a range of age that the subject has an 80% probability of falling within. As used herein, “making a measurement” and similar phrases may refer to measuring a plurality of quantities.

The invention has been described in the context of the best mode for carrying it out. It should be understood that not all features shown in the drawings or described in the associated text may be present in an actual device, in accordance with some embodiments of the invention. Furthermore, variations on the method and apparatus shown are included within the scope of the invention, which is limited only by the claims. Also, features of one embodiment may be provided in conjunction with features of a different embodiment of the invention. As used herein, the terms “have”, “include” and “comprise” or their conjugates mean “including but not limited to.”

1. A method of estimating a range of age of a subject, the method comprising:
a) making at least one measurement of epidermal ridges of the subject; and
b) estimating at least a range of age of the subject, using the measurements of the epidermal ridges, without using the measurements to identify the subject.

2. A method according to claim 1, also including scanning the epidermal ridges to produce a scanned image, wherein making the measurement comprises analyzing the scanned image.

3. A method according to claim 1, wherein the measurement comprises a measurement of an average distance between adjacent epidermal ridges.

4. A method according to claim 3, wherein the epidermal ridges are on a finger pad.

5. A method according to claim 4, wherein the finger pad is an index finger pad, and the subject is estimated to be under 17 years old if an average distance between adjacent ridges is less than 0.477 mm when the index finger is pressed against a surface.

6. A method according to claim 4, wherein the finger pad is an index finger pad, and the subject is estimated to be at least 17 years old if an average distance between adjacent ridges is at least 0.477 mm when the index finger is pressed against a surface.

7. A method according to claim 3, wherein the average distance between adjacent ridges is an average over ridges in a region of the skin where the ridges are substantially straight.

8. A method according to claim 3, wherein estimating the range of age comprises using other biometric data of the subject, combined with the average distance between adjacent ridges.

9. A method according to claim 8, wherein the other biometric data comprises a measure of the width of a finger pad.

10. A method according to claim 9, wherein the subject is estimated to be at least 17 years old if the product of the average distance between adjacent ridges of the index finger pad, and the width of the index finger pad, is greater than 6.60 mm² when the index finger is pressed against a surface.

11. A method according to claim 9, wherein the subject is estimated to be less than 17 years old if the product of the average distance between adjacent ridges of the index finger pad, and the width of the index finger pad, is less than 6.60 mm² when the index finger is pressed against a surface.

12. A method according to claim 8, wherein the other biometric data comprises data of the voice of the subject.

13. A method according to claim 1, wherein the subject is estimated to be an adult or not an adult, depending on whether a measure of the epidermal ridges on a subject is greater than or less than a value, the value being selected according to distributions of said measure for a population of adults and for a population of youths.

14. A method according to claim 13, wherein at least 70% of the population of adults have said measure greater than the value.

15. A method according to claim 13, wherein at least 70% of the population of youths have said measure less than the value.

16. A method according to claim 13, wherein the percentage of the population of youths who have said measure less than the value is substantially equal to the percentage of the population of adults who have said measure greater than the value.

17. A method according to claim 13, wherein the population of youths is between 13 and 16 years old.

18. A method according to claim 13, wherein the measure is an average distance between adjacent epidermal ridges on one of the finger pads.

19. A method according to claim 13, wherein the measure is the product of an average distance between adjacent epidermal ridges on one of the finger pads and a width of said finger pad.

20. A method according to claim 1, also including deciding whether to permit or deny the subject access to a resource, depending on the estimated range of age.

21. A method according to claim 20, wherein the resource comprises a pornographic website.

22. A method according to claim 20, wherein the resource comprises a gambling website.

23. A method according to claim 20, wherein the resource comprises an internet site for children, and the subject is denied access if the estimated range of age is greater than a maximum age.

24. Apparatus for estimating a range of age of a subject, the apparatus comprising:
a) a data acquisition device adapted to obtain data of the subject's epidermal ridges; and
b) an analyzer adapted to obtain at least one measurement of an average distance between adjacent epidermal ridges by analyzing the data and to estimate the range of age of the subject by analyzing the at least one measurements.

25. Apparatus according to claim 24, wherein the data acquisition device has a resolution that is worse than 0.05 mm.

26. Apparatus according to claim 25, wherein the data acquisition device has a resolution that is worse than 0.1 mm.

27. A system for controlling access to a resource by users under a minimum age for access, the system comprising:
a) apparatus according to claim 24, adapted to estimate the range of age of each of the users; and
b) a controller, adapted to deny access to a user, according to a relationship between the estimated range of age of the user, and the minimum age for access.

28. A system according to claim 27, wherein the apparatus is also adapted to establish the identity of a user by comparing imaging data of the user's finger pad to a database of finger pad ridge patterns, and the controller is adapted to deny access to the user, according to the estimated range of age of the user, or the identity established for the user, or both.

29. A system according to claim 27, wherein the apparatus is adapted to repeatedly estimate the age of each user while said user is using the resource, and the controller is adapted to terminate access by said user according to a relationship between an estimated range of age of the user made while the user is using the resource and the minimum age for access.
